(19) United States
(12) Patent Application Publication
(10) Pub. No.: US 2018/0046323 A1
(43) Pub. Date: Feb. 15, 2018

(54) Method And Device For Setting Working Frequency Band Of Touch Detection System

(71) Applicants: BOE Technology Group Co., Ltd., Beijing (CN); Hefei BOE Optoelectronics Technology Co., Ltd., Anhui (CN)

(72) Inventors: Qing Yang, Beijing (CN); Lei Hua, Beijing (CN); Changjun Zhang, Beijing (CN); Jian He, Beijing (CN); Lingling Liu, Beijing (CN)

(21) Appl. No.: 15/534,669

(22) PCT Filed: Oct. 8, 2016
(86) PCT No.: PCT/CN2016/101451

§ 371 Date: Jun. 9, 2017

(30) Foreign Application Priority Data
Jan. 5, 2016 (CN) 201610006096.1

(51) Int. Cl. G06F 3/041

(52) U.S. Cl. CPC G06F 3/0418; G06F 3/0412

(57) ABSTRACT

The present disclosure discloses a method and a system for setting working frequency band of a touch detection system. A method for setting working frequency band of a touch detection system includes the following steps of: collecting noise frequency spectrogram in a touch detection system of a touch apparatus in a normal operation mode; and, determining a frequency band which is within whole frequency band supported by the touch detection system and in which amplitude of the noise is less than a first threshold, according to the noise frequency spectrogram collected; and setting the frequency band in which amplitude of the noise is less than the first threshold to be effective working frequency band of the touch detection system. Meanwhile, the present disclosure also discloses a method and a system for suppressing noise in a touch detection system.

### CROSS-REFERENCE TO RELATED APPLICATION

This application is a Section 371 National Stage Application of International Application No. PCT/CN2016/101451, filed on 8 Oct. 2016, which has not yet published, and claims priority to Chinese Patent Application No. 201610006096.1 filed on Jan. 5, 2016 in the State Intellectual Property Office of China, the disclosures of which are incorporated herein by reference.

### BACKGROUND

### 1. Technical Field

The present disclosure relates to a method and a device for setting working frequency band of a touch detection system, and a method and a device for suppressing noise in the touch detection system.

### 2. Description of the Related Art

Generally speaking, noise will affect detection sensitivity of a touch detection system to a touch action, in a touch apparatus. If there has excessive amplitude of noise (noise intensity), it will reduce detection sensitivity of the touch detection system, and even leads to that the touch detection system will not correctly detect a touch action. Accordingly, in practical application, it is hopeful that the touch detection system works in conditions of minimum amplitude of the noise, to improve detection sensitivity of the touch detection system.

Since amplitude of the noise is related to working frequency of the touch detection system, in practical application, it needs to seek an optimal frequency that corresponds to minimum amplitude of the noise. However, in prior art, working frequency band of a touch detection system in a touch apparatus is generally set directly to be whole working frequency band supported by the touch detection system. As a result, in prior art, in order to seek an optimal working frequency of the touch detection system, it needs to scan all the frequencies of the entire frequency band supported by the touch detection system. This leads to a too wider range of the frequency band to be scanned, increases the time required for the frequency scanning and power consumption of the touch sensor, and also leads to frequent switching between the working frequency points, resulting in frame loss of the data, thereby causing adverse conditions including faults, breakages and suspensions, etc. to occur in the touch apparatus.

### SUMMARY

In one aspect of the present disclosure, there is provided a method for setting working frequency band of a touch detection system, and the method comprises the following steps of:

S110: collecting a noise frequency spectrogram of a touch detection system of a touch apparatus in a normal operation mode; and

S120: determining a frequency band which is within whole frequency band supported by the touch detection system and in which amplitude of the noise is less than a first threshold, according to the noise frequency spectrogram collected; and setting the frequency band in which amplitude of the noise is less than the first threshold to be effective working frequency band of the touch detection system.

In accordance with an exemplary embodiment, in the abovementioned method, the noise frequency spectrogram of the touch detection system of the touch apparatus in the normal operation mode is collected by a frequency spectrum scanning module embedded in the touch apparatus.

In accordance with an exemplary embodiment, in the abovementioned method, the normal operation mode comprises at least one of the operation modes including: operation of the touch apparatus when the touch apparatus is being charged, operation of the touch apparatus when the touch apparatus is held in hand, operation of the touch apparatus when the touch apparatus is placed on table, and operation of the touch apparatus when the touch apparatus is displaying a picture.

In accordance with an exemplary embodiment, in the abovementioned method, the first threshold is determined based on whether or not the touch detection system of the touch apparatus is capable of detecting properly a touch action in the normal operation mode.

In accordance with an exemplary embodiment, the abovementioned method may further comprise a step of: storing the effective working frequency band into a memory of the touch apparatus.

In another aspect of the present disclosure, there is provided a method for suppressing noise in a touch detection system, and the method comprises the following steps of:

S210: collecting noise frequency spectrogram of a touch detection system of a touch apparatus in a normal operation mode;

S220: determining a frequency band which is within whole frequency band supported by the touch detection system and in which amplitude of the noise is less than a first threshold, according to the noise frequency spectrogram collected; and setting the frequency band in which amplitude of the noise is less than the first threshold to be effective working frequency band of the touch detection system;

S230: setting certain driving frequency in the effective working frequency band to be an initial working frequency of the touch detection system;

S240: driving the touch detection system at the initial working frequency, and detecting amplitude of the noise in the touch detection system when the touch detection system is driven at the initial working frequency;

S250: judging whether or not amplitude of the noise in the touch detection system when the touch detection system is driven at the initial working frequency is greater than the first threshold, and, if no, going back to the step S240, or if yes, continuing to execute the following step S260;

S260: driving the touch detection system at driving frequencies in the effective working frequency band in sequence, and detecting amplitude of the noise of the touch detection system when the touch detection system is driven at each of the driving frequencies; and

S270: hopping to a driving frequency that corresponds to minimum amplitude of the noise, and driving the touch detection system at the driving frequency that corresponds to the minimum amplitude of the noise.

In accordance with an exemplary embodiment, in the abovementioned method, the step S230 comprises: determining a frequency which is within whole frequency band supported by the touch detection system and at which amplitude of the noise is minimum, according to the noise frequency spectrogram collected; and setting the frequency at which amplitude of the noise is minimum to be the initial working frequency of the touch detection system.

In accordance with an exemplary embodiment, in the abovementioned method, the noise frequency spectrogram of the touch detection system of the touch apparatus in the normal operation mode is collected by a frequency spectrum scanning module embedded in the touch apparatus.

In accordance with an exemplary embodiment, in the abovementioned method, the normal operation mode comprises at least one of the operation modes including: operation of the touch apparatus when the touch apparatus is being charged, operation of the touch apparatus when the touch apparatus is held in hand, operation of the touch apparatus when the touch apparatus is placed on table, and operation of the touch apparatus when the touch apparatus is displaying a picture.

In accordance with an exemplary embodiment, in the abovementioned method, the first threshold is determined based on whether or not the touch detection system of the touch apparatus is capable of detecting properly a touch action in the normal operation mode.

In accordance with an exemplary embodiment, the abovementioned method may further comprise a step of: storing the effective working frequency band and the initial working frequency into a memory of the touch apparatus.

In yet another aspect of the present disclosure, there is provided a device for setting working frequency band of a touch detection system, and the device comprises:

a noise frequency spectrum collecting unit configured to collect a noise frequency spectrogram of a touch detection system of a touch apparatus in a normal operation mode; and

a working frequency band setting unit configured to determine a frequency band which is within whole frequency band supported by the touch detection system and in which amplitude of the noise is less than a first threshold, according to the noise frequency spectrogram collected; and to set the frequency band in which amplitude of the noise is less than the first threshold to be effective working frequency band of the touch detection system.

In accordance with an exemplary embodiment, in the abovementioned device, the noise frequency spectrum collecting unit comprises a frequency spectrum scanning module embedded in the touch apparatus.

In accordance with an exemplary embodiment, the abovementioned device may further comprise: a storage unit configured to store the effective working frequency band.

In another aspect of the present disclosure, there is provided a system for suppressing noise in a touch detection system, and the system comprises:

a noise frequency spectrum collecting unit configured to collect noise frequency spectrogram in a touch detection system of a touch apparatus in a normal operation mode;

a working frequency band setting unit configured to determine a frequency band which is within whole frequency band supported by the touch detection system and in which amplitude of the noise is less than a first threshold, according to the noise frequency spectrogram collected; and to set the frequency band in which amplitude of the noise is less than the first threshold to be effective working frequency band of the touch detection system;

an initial working frequency setting unit configured to set certain frequency in the effective working frequency band to be an initial working frequency of the touch detection system;

a driving unit configured to drive the touch detection system at any of driving frequencies in the effective working frequency band;

a driving control unit configured to control the driving unit to drive the touch detection system at the initial working frequency, and to control the driving unit to drive the touch detection system at the driving frequencies of the effective working frequency band in sequence;

a noise detecting unit configured to detect amplitude of the noise in the touch detection system when the touch detection system is driven by the driving unit at each of the driving frequencies;

a judging unit configured to judge whether or not the amplitude of the noise in the touch detection system which is detected when the touch detection system is driven at the initial working frequency is greater than the first threshold; if yes, to control the driving unit to drive the touch detection system at the driving frequencies of the initial working frequency band in sequence; and if no, to control the driving unit to continue to drive the touch detection system at the initial working frequency; and

a hopping control unit configured to determine a driving frequency that corresponds to minimum amplitude of the noise in accordance with a result of detection of the noise detecting unit, and to control the driving unit to drive the touch detection system at the driving frequency that corresponds to the minimum amplitude of the noise.

In accordance with an exemplary embodiment, in the abovementioned device, the noise frequency spectrum collecting module comprises a frequency spectrum scanning module embedded in the touch apparatus.

In accordance with an exemplary embodiment, the abovementioned device may further comprise: a storage unit configured to store the effective working frequency band and the initial working frequency.

Other objects and advantages of the present disclosure will become apparent and more readily appreciated from the following description of the embodiments, taken in conjunction with the accompanying drawings. And it is helpful to bring a complete understanding on the present disclosure.

### BRIEF DESCRIPTION OF THE DRAWINGS

FIG. 1 schematically shows a noise frequency spectrogram of a touch detection system of a touch apparatus in a normal operation mode;

FIG. 2 shows a flow chart of a method for setting a working frequency band of a touch detection system according to an exemplary embodiment of the present disclosure;

FIG. 3 shows a flow chart of a method for suppressing a noise in a touch detection system according to an exemplary embodiment of the present disclosure;

FIG. 4 shows a block diagram of a device for setting a working frequency band of a touch detection system according to an exemplary embodiment of the present disclosure; and

FIG. 5 shows a block diagram of a device for suppressing a noise in a touch detection system according to an exemplary embodiment of the present disclosure.

### DETAILED DESCRIPTION OF THE EMBODIMENTS

Technical solutions of the present disclosure will be further described in detail from the following description of the embodiments with reference to the attached drawings. In this description, the like or similar reference numerals refer to the like or similar elements. The following description of the embodiments with reference to the attached drawings intends to explain a general inventive idea of the present disclosure, and should not be construed to limit the present disclosure.

In addition, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In accordance with a general technical concept, there is provided a method for setting working frequency band of a touch detection system, and the method comprises the following steps of: collecting a noise frequency spectrogram of a touch detection system of a touch apparatus in a normal operation mode; and, determining a frequency band which is within whole frequency band supported by the touch detection system and in which amplitude of the noise is less than a first threshold, according to the noise frequency spectrogram collected; and setting the frequency band in which amplitude of the noise is less than the first threshold to be effective working frequency band of the touch detection system.

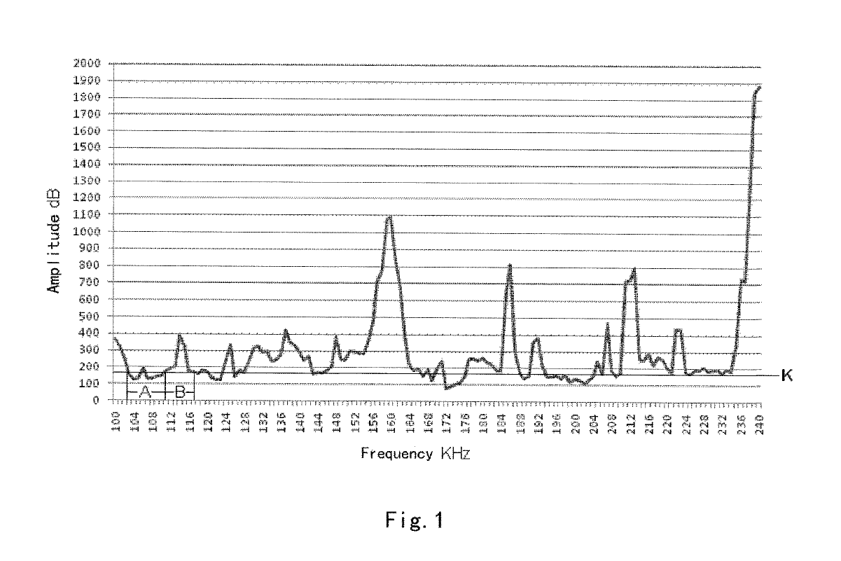

FIG. 1 schematically shows a noise frequency spectrogram of a touch detection system of a touch apparatus in a normal operation mode.

Referring to FIG. 1, horizontal ordinate denotes whole frequency band supported by the touch detection system, and vertical coordinate denotes amplitude of the noise in the touch detection system.

In the shown embodiment, referring to FIG. 1, provided that the whole frequency band supported by the touch detection system is ranged from 100 KHz to 240 KHz, whatever, it should be noted that, FIG. 1 merely is an exemplary example, and the range of the whole frequency band supported by the touch detection system is not confined to those in the shown embodiments, for example, the range of the whole frequency band supported by the touch detection system may be ranged from 100 KHz to 700 KHz.

It can be learned clearly from FIG. 1 that, amplitude of the noise in the touch detection system is related to frequency of the touch detection system. There are minor amplitudes of the noise at some certain frequencies, and there are larger amplitudes of the noise at some other frequencies. In a normal operation, the touch detection system cannot detect properly a touch action once amplitude of the noise of the touch detection system is greater than certain preset threshold (also named as a first threshold) K. Accordingly, in practical application, amplitude of the noise in the touch detection system must be controlled to be below the preset threshold K. In the shown embodiment, referring to FIG. 1, the preset threshold K may be set to be 180 dB. However, it should be noted that, the present disclosure is not confined to those in the shown embodiments, and size of the preset threshold K may be chosen and determined in accordance with practical situations, for example, the preset threshold K may be also set to be 160 dB or less.

In the shown embodiment of FIG. 1, within the whole frequency band (from 100 KHz to 240 KHz) supported by the touch detection system, a frequency band A(, only a portion of the frequency band A is shown in FIG. 1,) in which amplitude of the noise is less than the preset threshold K accounts for only a small proportion of the whole frequency band supported by the touch detection system, while the rest is a frequency band B (, only a portion of the frequency band B is shown in FIG. 1,) in which amplitude of the noise is greater than the preset threshold K. In this description, the frequency band A which is within the whole frequency band supported by the touch detection system and in which amplitude of the noise is less than the preset threshold K is set to be an effective working frequency band of the touch detection system, while the frequency band B which is within the whole frequency band supported by the touch detection system and in which amplitude of the noise is greater than the preset threshold K is set to be an ineffective working frequency band (, also named as unsuitable working frequency band,) of the touch detection system.

In an exemplary embodiment of the present disclosure, a noise frequency spectrogram of the touch detection system of the touch apparatus in a normal operation mode can be obtained by spectrum scanning device. For example, in manufacturing plant or laboratory, a normal operation of the touch apparatus by consumer can be simulated, and the noise frequency spectrogram of the touch detection system of the touch apparatus in a normal operation mode can be collected by using spectrum analyzer that is independent of the touch apparatus.

In another exemplary embodiment of the present disclosure, the noise frequency spectrogram of the touch detection system of the touch apparatus in the normal operation mode may be collected by a frequency spectrum scanning module embedded in the touch apparatus.

In the aforementioned embodiment, a normal operation mode of a consumer may comprise at least one of the following operation modes including: operation of the touch apparatus when the touch apparatus is being charged, operation of the touch apparatus when the touch apparatus is held in hand, operation of the touch apparatus when the touch apparatus is placed on table, and operation of the touch apparatus when the touch apparatus is displaying a picture.

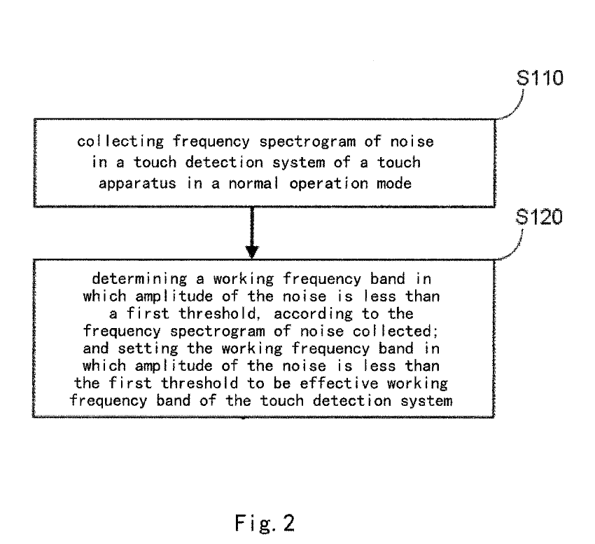

FIG. 2 shows a flow chart of a method for setting a working frequency band of a touch detection system according to an exemplary embodiment of the present disclosure.

A method of setting a working frequency band of a touch detection system will be described and explained hereinafter in conjunction with FIG. 1 and FIG. 2. Referring to FIG. 2, the method of setting the working frequency band of the touch detection system mainly comprises the following steps of:

S110: collecting a noise frequency spectrogram of a touch detection system of a touch apparatus in a normal operation mode; and

S120: determining a frequency band A which is within whole frequency band supported by the touch detection system and in which amplitude of the noise is less than a first threshold K, according to the noise frequency spectrogram collected; and setting the frequency band in which amplitude of the noise is less than the first threshold K to be effective working frequency band of the touch detection system.

In an embodiment of the present disclosure, the effective working frequency band may be stored into a memory of the touch apparatus. In this way, the effective working frequency band can be obtained directly from the memory if it is required to perform a frequency scanning

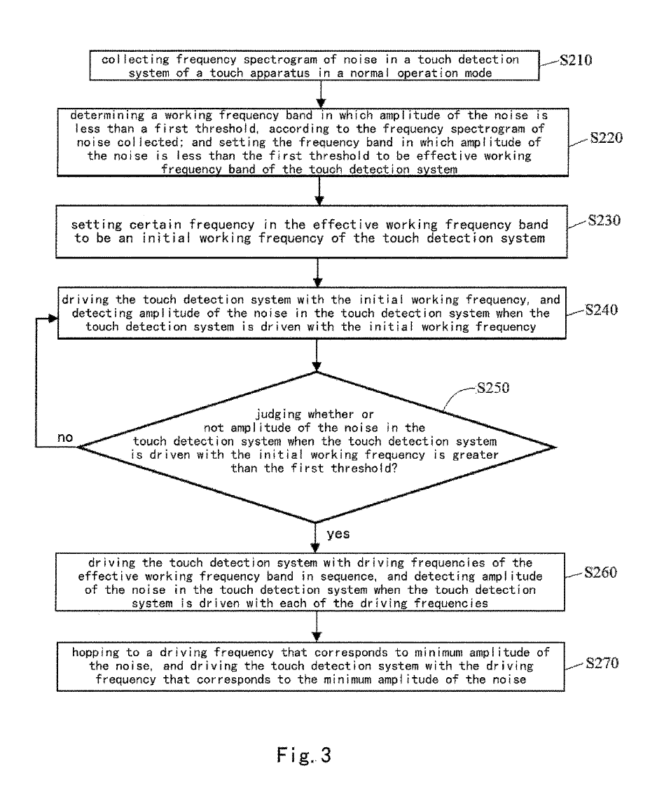

FIG. 3 shows a flow chart of a method for suppressing a noise in a touch detection system according to an exemplary embodiment of the present disclosure.

A method of suppressing a noise of a touch detection system will be described and explained hereinafter in conjunction with FIG. 1 and FIG. 3. Referring to FIG. 3, the method of suppressing the noise of the touch detection system mainly comprises the following steps of:

S210: collecting a noise frequency spectrogram of a touch detection system of a touch apparatus in a normal operation mode;

S220: determining a frequency band A which is within whole frequency band supported by the touch detection system and in which amplitude of the noise is less than a first threshold K, according to the noise frequency spectrogram collected; and setting the frequency band A in which amplitude of the noise is less than the first threshold to be effective working frequency band of the touch detection system;

S230: setting certain driving frequency in the effective working frequency band to be an initial working frequency of the touch detection system;

S240: driving the touch detection system at the initial working frequency, and detecting amplitude of the noise in the touch detection system when the touch detection system is driven at the initial working frequency;

S250: judging whether or not amplitude of the noise in the touch detection system when the touch detection system is driven at the initial working frequency is greater than the first threshold, if no, going back to the step S240, and if yes, continuing to execute the following step S260;

S260: driving the touch detection system at driving frequencies of the effective working frequency band in sequence, and detecting amplitude of the noise in the touch detection system when the touch detection system is driven at each of the driving frequencies; and

S270: hopping to a driving frequency that corresponds to minimum amplitude of the noise, and driving the touch detection system at the driving frequency that corresponds to the minimum amplitude of the noise.

In an exemplary embodiment of the present disclosure, the aforementioned step S230 may comprise: determining a frequency which is within whole frequency band supported by the touch detection system and at which amplitude of the noise is minimum, according to the noise frequency spectrogram collected; and setting the frequency at which amplitude of the noise is minimum to be an initial working frequency of the touch detection system.

In an exemplary embodiment of the present disclosure, the effective working frequency band and the initial working frequency may be stored into a memory of the touch apparatus. In this way, the effective working frequency band and the initial working frequency can be obtained directly from the memory.

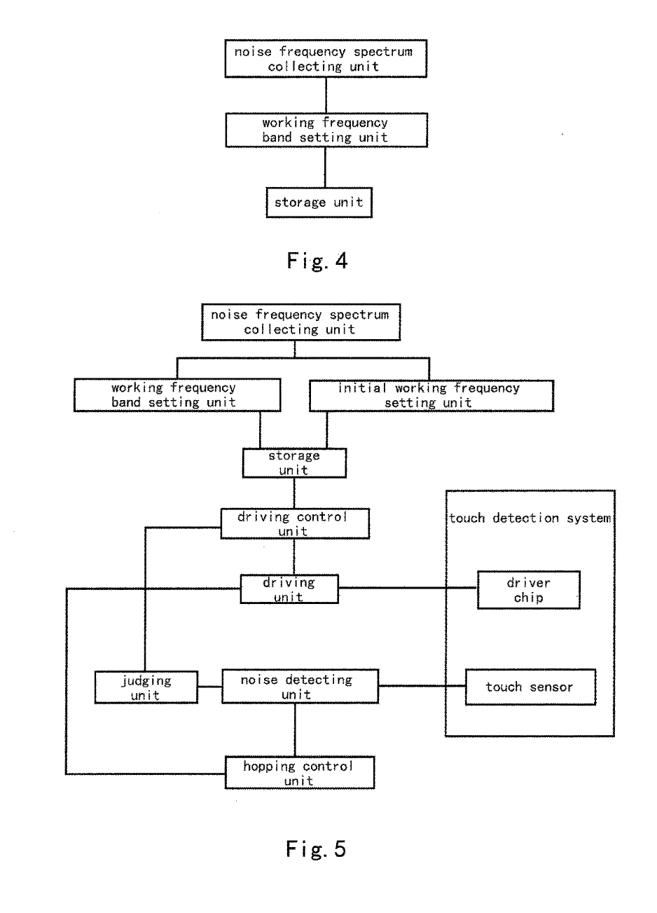

FIG. 4 shows a block diagram of a device for setting a working frequency band of a touch detection system according to an exemplary embodiment of the present disclosure.

A device for setting working frequency band of a touch detection system will be described and explained hereinafter in conjunction with FIG. 4. Referring to FIG. 4, in the shown embodiment, the device for setting working frequency band of the touch detection system mainly comprises a noise frequency spectrum collecting unit and a working frequency band setting unit. The noise frequency spectrum collecting unit is configured to collect a noise frequency spectrogram in a touch detection system of a touch apparatus in a normal operation mode. The working frequency band setting unit is configured to determine a frequency band which is within whole frequency band supported by the touch detection system and in which amplitude of the noise is less than a first threshold, according to the noise frequency spectrogram collected; and to set the frequency band in which amplitude of the noise is less than the first threshold to be effective working frequency band of the touch detection system.

In an exemplary embodiment of the present disclosure, the noise frequency spectrum collecting unit may comprise a frequency spectrum scanning module embedded in the touch apparatus. In this way, the noise frequency spectrogram of the touch detection system of the touch apparatus in the normal operation mode can be collected by the frequency spectrum scanning module embedded in the touch apparatus.

In an exemplary embodiment of the present disclosure, the device for setting working frequency band of the touch detection system may further comprise a storage unit configured to store the effective working frequency band.

FIG. 5 shows a block diagram of a device for suppressing a noise in a touch detection system according to an exemplary embodiment of the present disclosure.

A device for suppressing noise in a touch detection system will be described and explained hereinafter in conjunction with FIG. 5. Referring to FIG. 5, in the shown embodiment, the device for suppressing the noise of the touch detection system mainly comprises: a noise frequency spectrum collecting unit, a working frequency band setting unit, an initial working frequency setting unit, a driving unit, a driving control unit, a noise detecting unit, a judging unit and a hopping control unit.

Referring to FIG. 5, in the shown embodiment, the noise frequency spectrum collecting unit is configured to collect a noise frequency spectrogram of a touch detection system of a touch apparatus in a normal operation mode. The working frequency band setting unit is configured to determine a frequency band which is within whole frequency band supported by the touch detection system and in which amplitude of the noise is less than a first threshold, according to the noise frequency spectrogram collected; and to set the frequency band in which amplitude of the noise is less than the first threshold to be effective working frequency band of the touch detection system. The initial working frequency setting unit is configured to set certain driving frequency in the effective working frequency band to be an initial working frequency of the touch detection system. The driving unit is configured to drive the touch detection system at any of frequencies in the effective working frequency band. The driving control unit is configured to control the driving unit to drive the touch detection system at the initial working frequency, and to control the driving unit to drive the touch detection system at driving frequencies of the effective working frequency band in sequence. The noise detecting unit is configured to detect amplitude of the noise in the touch detection system when the touch detection system is driven by the driving unit at each of the driving frequencies. The judging unit is configured to judge whether or not the amplitude of the noise in the touch detection system which is detected when the touch detection system is driven at the initial working frequency is greater than the first threshold; if yes, to control the driving unit to drive the touch detection system at the driving frequencies of the initial working frequency band in sequence; and if no, to control the driving unit to continue to drive the touch detection system at the initial working frequency. The hopping control unit is configured to determine a driving frequency that corresponds to minimum amplitude of the noise in accordance with a result of detection of the noise detecting unit, and to control the driving unit to drive the touch detection system at the driving frequency that corresponds to the minimum amplitude of the noise.

In an exemplary embodiment of the present disclosure, the aforementioned device for suppressing noise in the touch detection system may further comprise a storage unit configured to store the effective working frequency band and the initial working frequency.

In these aforementioned exemplary embodiments of the present disclosure, certain frequency band, which is within whole frequency band supported by the touch detection system and in which amplitude of the noise is less than a preset threshold, is set to be effective working frequency band of the touch detection system. In this way, unsuitable frequency band (also named as ineffective working frequency band), which is within whole frequency band supported by the touch detection system but in which amplitude of the noise is greater than a preset threshold, can be removed, narrowing scope of the working frequency band of the touch detection system. Accordingly, in the present disclosure, when it needs to seek an optimal working frequency of the touch detection system, there merely requires to scan frequencies within effective working frequency band in which amplitude of the noise is less than the preset threshold, instead of scanning all the frequencies of the whole frequency band supported by the touch detection system, so that, the range of frequency scanning is narrowed, and thus the time required for the frequency scanning and power consumption of the touch sensor are reduced. In addition, in the present disclosure, the range of effective working frequency band to be scanned is greatly narrowed, accordingly, times of frequent switching between the working frequency points during scanning are also reduced, which effectively avoids adverse conditions including faults, breakages and suspensions, etc. to occur in the touch apparatus.

It would be appreciated by those skilled in the art that the abovementioned embodiments are exemplary, and those skilled in the art may make any modifications. Structures described in these embodiments may be combined freely without involving any structural or principal conflictions

Although the present disclosure has been described in conjunction with the drawings, these embodiments disclosed in the drawings intend to exemplarily illustrate preferred embodiments of the present disclosure, but not to limit the present disclosure.

Although some embodiments of the general inventive concept have been shown and described, it will be apparent, however, for those skilled in the art that make changes on these embodiments may be made in these embodiments without departing from the principles and spirit of the general inventive concept of the present disclosure, the scope of which is defined in the claims and their equivalents.

It should be note that, terminologies, such as “comprise/comprising”, “include/including” and the like do not exclude any additional elements or steps, and terminologies, such as “a/one” do not exclude a plurality of elements. In addition, any reference numerals for elements claimed in claims should not be understood as limiting the scope of the present disclosure.

1. A method for setting working frequency band of a touch detection system, the method comprising the following steps of:
S110: collecting a noise frequency spectrogram of a touch detection system of a touch apparatus in a normal operation mode; and
S120: determining a frequency band which is within whole frequency band supported by the touch detection system and in which amplitude of the noise is less than a first threshold, according to the noise frequency spectrogram collected; and setting the frequency band in which amplitude of the noise is less than the first threshold to be effective working frequency band of the touch detection system.

2. The method for setting working frequency band of a touch detection system according to claim 1, wherein,
the noise frequency spectrogram of the touch detection system of the touch apparatus in the normal operation mode is collected by a frequency spectrum scanning module embedded in the touch apparatus.

3. The method for setting working frequency band of the touch detection system according to claim 1, wherein,
the normal operation mode comprises at least one of the operation modes including:
operation of the touch apparatus when the touch apparatus is being charged, operation of the touch apparatus when the touch apparatus is held in hand, operation of the touch apparatus when the touch apparatus is placed on table, and operation of the touch apparatus when the touch apparatus is displaying a picture.

4. The method for setting working frequency band of the touch detection system according to claim 3, wherein,
the first threshold is determined based on whether or not the touch detection system of the touch apparatus is capable of detecting properly a touch action in the normal operation mode.

5. The method for setting working frequency band of the touch detection system according to claim 1, further comprising a step of:
storing the effective working frequency band into a memory of the touch apparatus.

6. A method for suppressing noise in a touch detection system, the method comprising the following steps of:
S210: collecting noise frequency spectrogram of a touch detection system of a touch apparatus in a normal operation mode;
S220: determining a frequency band which is within whole frequency band supported by the touch detection system and in which amplitude of the noise is less than a first threshold, according to the noise frequency spectrogram collected; and setting the frequency band in which amplitude of the noise is less than the first threshold to be effective working frequency band of the touch detection system;
S230: setting certain driving frequency in the effective working frequency band to be an initial working frequency of the touch detection system;
S240: driving the touch detection system at the initial working frequency, and detecting amplitude of the noise in the touch detection system when the touch detection system is driven at the initial working frequency;
S250: judging whether or not amplitude of the noise in the touch detection system when the touch detection system is driven at the initial working frequency is greater than the first threshold, and, if no, going back to the step 5240, or if yes, continuing to execute the following step S260;
S260: driving the touch detection system at driving frequencies in the effective working frequency band in sequence, and detecting amplitude of the noise of the touch detection system when the touch detection system is driven at each of the driving frequencies; and
S270: hopping to a driving frequency that corresponds to minimum amplitude of the noise, and driving the touch detection system at the driving frequency that corresponds to the minimum amplitude of the noise.

7. The method for suppressing the noise in the touch detection system according to claim 6, wherein, the step S230 comprises:
determining a frequency which is within whole frequency band supported by the touch detection system and at which amplitude of the noise is minimum, according to the noise frequency spectrogram collected; and setting the frequency at which amplitude of the noise is minimum to be the initial working frequency of the touch detection system.

8. The method for suppressing the noise in the touch detection system according to claim 6, wherein:
the noise frequency spectrogram of the touch detection system of the touch apparatus in the normal operation mode is collected by a frequency spectrum scanning module embedded in the touch apparatus.

9. The method for suppressing the noise in the touch detection system according to claim 6, wherein:
the normal operation mode comprises at least one of the operation modes including: operation of the touch apparatus when the touch apparatus is being charged, operation of the touch apparatus when the touch apparatus is held in hand, operation of the touch apparatus when the touch apparatus is placed on table, and operation of the touch apparatus when the touch apparatus is displaying a picture.

10. The method for suppressing the noise in the touch detection system according to claim 9, wherein:
the first threshold is determined based on whether or not the touch detection system of the touch apparatus is capable of detecting properly a touch action in the normal operation mode.

11. The method for suppressing the noise in the touch detection system according to claim 6, further comprising a step of:
storing the effective working frequency band and the initial working frequency into a memory of the touch apparatus.

12. A device for setting working frequency band of a touch detection system according to claim 1, the device comprising:
a noise frequency spectrum collecting unit configured to collect a noise frequency spectrogram of a touch detection system of a touch apparatus in a normal operation mode; and
a working frequency band setting unit configured to determine a frequency band which is within whole frequency band supported by the touch detection system and in which amplitude of the noise is less than a first threshold, according to the noise frequency spectrogram collected;
and to set the frequency band in which amplitude of the noise is less than the first threshold to be effective working frequency band of the touch detection system.

13. The device for setting working frequency band of the touch detection system according to claim 12, wherein, the noise frequency spectrum collecting unit comprises a frequency spectrum scanning module embedded in the touch apparatus.

14. The device for setting working frequency band of the touch detection system according to claim 12, further comprises:
a storage unit configured to store the effective working frequency band.

15. A device for implementing the method of suppressing noise in the touch detection system according to claim 6, comprising:
a noise frequency spectrum collecting unit configured to collect noise frequency spectrogram in a touch detection system of a touch apparatus in a normal operation mode;
a working frequency band setting unit configured to determine a frequency band which is within whole frequency band supported by the touch detection system and in which amplitude of the noise is less than a first threshold, according to the noise frequency spectrogram collected;
and to set the frequency band in which amplitude of the noise is less than the first threshold to be effective working frequency band of the touch detection system;
an initial working frequency setting unit configured to set certain frequency in the effective working frequency band to be an initial working frequency of the touch detection system;
a driving unit configured to drive the touch detection system at any of driving frequencies in the effective working frequency band;
a driving control unit configured to control the driving unit to drive the touch detection system at the initial working frequency, and to control the driving unit to drive the touch detection system at the driving frequencies of the effective working frequency band in sequence;
a noise detecting unit configured to detect amplitude of the noise in the touch detection system when the touch detection system is driven by the driving unit at each of the driving frequencies;
a judging unit configured to judge whether or not the amplitude of the noise in the touch detection system which is detected when the touch detection system is driven at the initial working frequency is greater than the first threshold; if yes, to control the driving unit to drive the touch detection system at the driving frequencies of the initial working frequency band in sequence; and if no, to control the driving unit to continue to drive the touch detection system at the initial working frequency; and
a hopping control unit configured to determine a driving frequency that corresponds to minimum amplitude of the noise in accordance with a result of detection of the noise detecting unit, and to control the driving unit to drive the touch detection system at the driving frequency that corresponds to the minimum amplitude of the noise.

16. The device for suppressing noise in the touch detection system according to claim 15, wherein:
the noise frequency spectrum collecting module comprises a frequency spectrum scanning module embedded in the touch apparatus.

17. The device for suppressing noise in the touch detection system according to claim 15, further comprises:
a storage unit configured to store the effective working frequency band and the initial working frequency.
